(19) United States
(12) Patent Application Publication
(10) Pub. No.: US 2019/0267880 A1
(43) Pub. Date: Aug. 29, 2019

(54) ACTUATOR AND CAMERA DEVICE

(71) Applicant: Panasonic Intellectual Property Management Co., Ltd., Osaka (JP)

(72) Inventors: Hirohide ICHIHASHI, Osaka (JP); Masakazu KOBAYASHI, Osaka (JP); Yasuaki KAMEYAMA, Osaka (JP); Tsutomu SHIMOMURA, Osaka (JP); Tsubasa HOSHINO, Osaka (JP)

(21) Appl. No.: 16/413,314

(22) Filed: May 15, 2019

Related U.S. Application Data
(63) Continuation of application No. PCT/JP2017/040205, filed on Nov. 8, 2017.

(30) Foreign Application Priority Data
Nov. 16, 2016 (JP) 2016-223286

(51) Int. Cl. H02K 33/16; G03B 15/00; G03B 17/56; G06F 3/0338; H04N 5/225; G03B 5/00

(52) U.S. Cl. CPC H02K 33/16; G03B 15/00; G03B 17/56; G03B 2205/0053; H04N 5/2251; G03B 5/00; G06F 3/0338

(57) ABSTRACT

An actuator includes drive magnets (first drive magnet and second drive magnet) and back yokes (first magnetic back yoke and second magnetic back yoke). The back yokes are each provided one to one for an associated one of the drive magnets. The associated one of the drive magnets is attached to each of the back yokes. The back yokes include at least one pair of back yokes facing each other with respect to an optical axis. Each of the at least one pair of back yokes includes a base and a yoke protrusion. An associated one of the drive magnets is attached to the base. The yoke protrusion is coupled to the base and arranged to face at least one out of two ends of the associated drive magnet in a rolling direction of a movable holder.

### CROSS-REFERENCE TO RELATED APPLICATIONS

This application is a U.S. continuation of International Patent Application No. PCT/JP2017/040205, filed on Nov. 8, 2017, which in turn claims the benefit of priority to Japanese Patent Application No. 2016-223286, filed on Nov. 16, 2016, the entire disclosures of which are hereby incorporated by reference.

### TECHNICAL FIELD

The present disclosure relates to an actuator and a camera device, and more particularly relates to an actuator and camera device configured to drive an object to be driven in rotation in a rolling direction.

### BACKGROUND ART

An actuator including an operating member mounted on a movable unit so as to rotate in three directions (namely, a rolling direction, a panning direction, and a tilting direction), and an input/output operating device including such an actuator, have been known in the art (see, for example, JP 2015-215730 A (hereinafter referred to as D1)).

The actuator of D1 includes a first driving unit for rotating the operating member around an X-axis (i.e., rotating it in the panning direction), a second driving unit for rotating the operating member around a Y-axis (i.e., rotating it in the tilting direction), and a third driving unit for rotating the operating member around a Z-axis (i.e., rotating it in the rolling direction).

The first driving unit includes a pair of first drive magnets arranged in the movable unit symmetrically with respect to the Z-axis and a pair of first magnetic yokes arranged in a fixed unit so as to face the pair of first drive magnets, respectively. The first driving unit further includes a pair of first drive coils wound around the pair of first magnetic yokes.

The second driving unit includes a pair of second drive magnets arranged in the movable unit symmetrically with respect to the Z-axis and a pair of second magnetic yokes arranged in the fixed unit so as to face the pair of second drive magnets, respectively. The second driving unit further includes a pair of second drive coils wound around the pair of second magnetic yokes.

The third driving unit includes third drive coils wound around the pair of first magnetic yokes and the pair of second magnetic yokes, and uses the pair of first drive magnets and the pair of second drive magnets as third drive magnets.

The pair of first drive magnets and the pair of second drive magnets are bonded with an adhesive onto magnetic back yokes in a generally rectangular parallelepiped shape. Coupling the magnetic back yokes to the movable unit allows the pair of first drive magnets and the pair of second drive magnets to be fixed onto the movable unit.

According to D1, when the attraction force produced between the first drive magnets and the first magnetic yokes and the attraction force produced between the second drive magnets and the second magnetic yokes are significant, the torque that makes the operating member (movable unit) rotate in the rolling direction could be insufficient. This would cause a decrease in the angle of rotation in the rolling direction of the operating member (movable unit).

### SUMMARY

The present disclosure provides an actuator and camera device with the ability to produce a torque required to rotate the movable unit in the rolling direction and to weaken the magnetic force between the drive magnets and the magnetic yokes.

An actuator according to an aspect of the present disclosure includes a movable holder, a fixed holder, a plurality of drive coil members, a plurality of drive magnets, and a plurality of back yokes. The movable holder holds an object to be driven thereon. The fixed holder holds the movable holder thereon so as to allow the movable holder to rotate around a predetermined first axis. The plurality of drive coil members are provided for the fixed holder, arranged to face each other with respect to the first axis, and configured to cause the movable holder to rotate around the first axis. The plurality of drive magnets are provided for the movable holder. The plurality of drive magnets are each arranged between the first axis and a facing one of the plurality of drive coil members such that respective first surfaces, having the same first magnetic pole, of the plurality of drive magnets face the plurality of drive coil members. The plurality of back yokes are each provided one to one for, and attached to, an associated one of the plurality of drive magnets so as to face a second surface of the associated one of the plurality of drive magnets. The second surface has a second magnetic pole opposite from the first magnetic pole. The plurality of drive coil members each include a yoke containing a magnetic material and a coil formed by winding a conductive wire around the yoke in a direction defined around a second axis that is perpendicular to the first axis. The plurality of back yokes includes at least one pair of back yokes facing each other with respect to the first axis. Each of the at least one pair of back yokes includes a base and a yoke protrusion. An associated one of the plurality of drive magnets is attached to the base. The yoke protrusion is coupled to the base and arranged to face at least one out of two ends of the associated drive magnet in a rolling direction of a movable holder.

A camera device according to another aspect of the present disclosure includes the actuator described above; and a camera module as the object to be driven.

### BRIEF DESCRIPTION OF DRAWINGS

FIG. 1A is a perspective view of a camera device including an actuator according to an embodiment of the present disclosure;

FIG. 1B is a cross-sectional view of the camera device taken along a plane defined by a Z-axis and an axis perpendicular to both an optical axis and the Z-axis;

FIG. 2 is a cross-sectional view of the camera device taken along a plane defined by an X-axis (or Y-axis) and the optical axis;

FIG. 3 is an exploded perspective view of the camera device;

FIG. 4 is an exploded perspective view of a movable unit included in the actuator;

FIG. 5A is a Z-Z cross-sectional view of a first magnetic back yoke (or second magnetic back yoke) and a first drive magnet (or second drive magnet) of the camera device;

FIG. 5B is a cross-sectional view illustrating a magnetic flux between the first drive magnet (or second drive magnet) and the first magnetic yoke (or second magnetic yoke);

FIG. 6A is a graph showing a relationship between an angle θ in the first magnetic back yoke (second-axis back yoke) of the camera device and a torque in the rolling direction;

FIG. 6B is a graph showing a relationship between a length L1 in the first magnetic back yoke (second-axis back yoke) of the camera device and the torque in the rolling direction;

FIG. 7 is a graph showing a relationship between an angle of rotation in a panning direction (or tilting direction) and a torque;

FIG. 8A illustrates a variation of the shape of a first magnetic back yoke (or second magnetic back yoke); and

FIG. 8B illustrates another variation of the shape of the first magnetic back yoke (or second magnetic back yoke).

### DESCRIPTION OF EMBODIMENTS

Note that embodiments and their variations to be described below are only examples of the present disclosure and should not be construed as limiting. Rather, those embodiments and variations may be readily modified in various manners depending on a design choice or any other factor without departing from a true spirit and scope of the present disclosure.

### First Embodiment

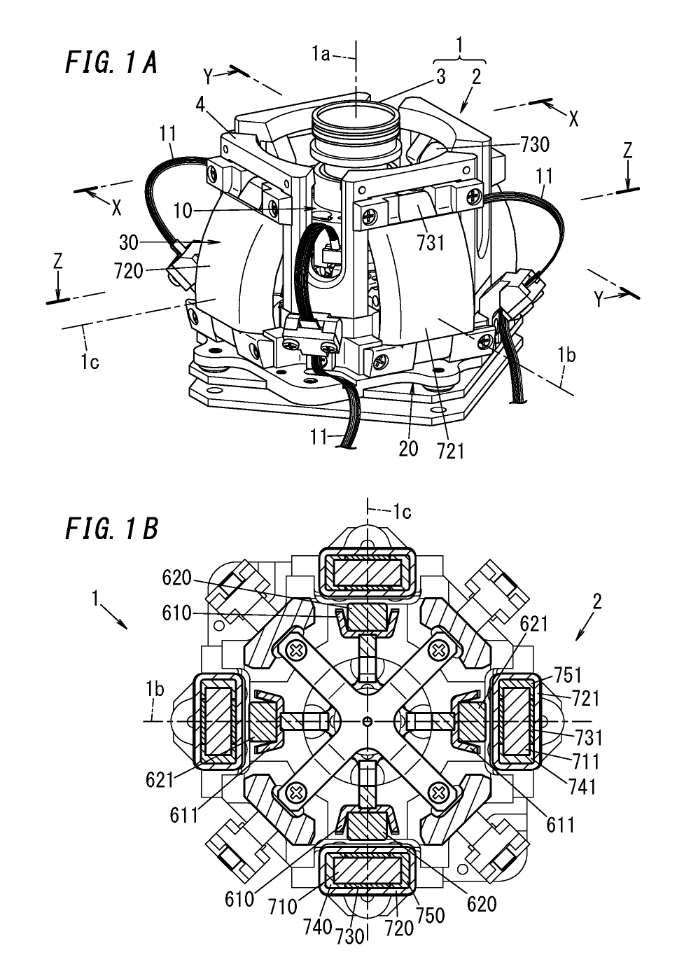

A camera device 1 according to this embodiment will be described with reference to FIGS. 1A-7.

The camera device 1 may be a portable camera, for example, and includes an actuator 2 and a camera module 3 as shown in FIGS. 1A, 2, and 3. The camera module 3 is rotatable in a tilting direction, a panning direction, and a rolling direction (to be described later). The actuator 2 serves as a stabilizer for reducing unnecessary vibrations of the camera module 3 by driving the camera module 3 as the object to be driven in a predetermined rotational direction.

The camera module 3 includes an image capture device 3a, a lens 3b to form a subject image on an image capturing plane of the image capture device 3a, and a lens barrel 3c to hold the lens 3b. The camera module 3 converts video produced on the image capturing plane of the image capture device 3a into an electrical signal. The lens barrel 3c protrudes in the direction in which the optical axis 1a of the camera module 3 extends. The lens barrel 3c has a circular cross section perpendicularly to the optical axis 1a. Also, a plurality of cables to transmit the electrical signal generated by the image capture device 3a to an external image processor circuit (as an exemplary external circuit) are electrically connected to the camera module 3 via connectors. In this embodiment, the plurality of cables are fine-line coaxial cables of the same length, and the number of cables provided is forty. Those cables (forty cables) are grouped into four bundles of cables 11, each consisting of ten cables. Note that the number of the cables provided (e.g., forty) is only an example and should not be construed as limiting.

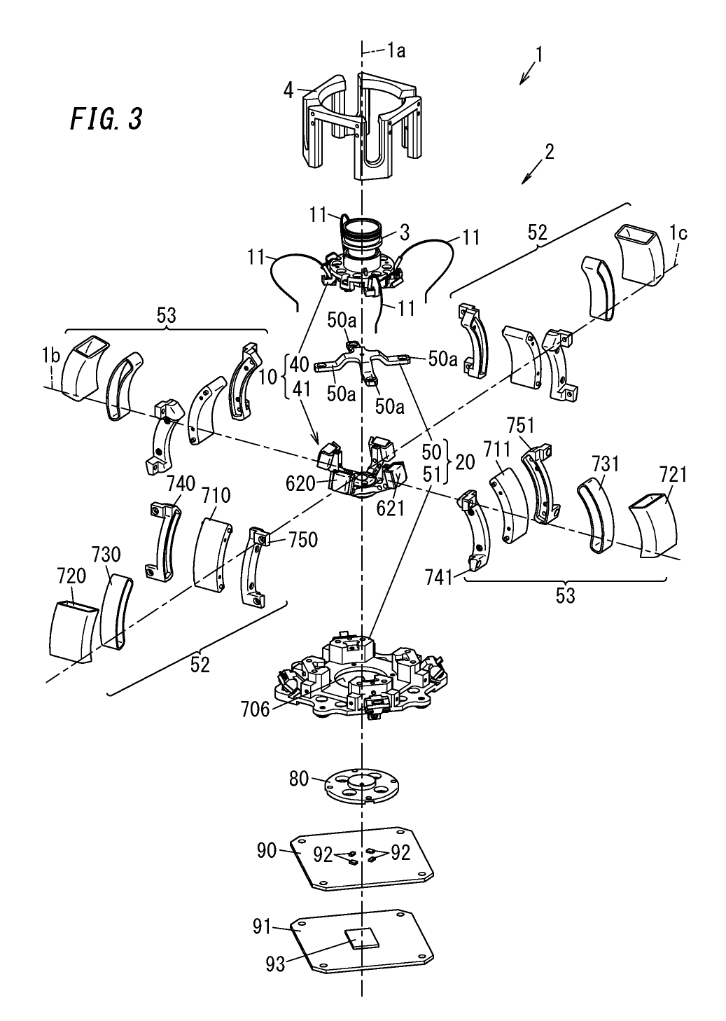

The actuator 2 includes an upper ring 4, a movable unit 10, a fixed unit 20, a driving unit 30, a stopper member 80, a first printed circuit board 90, and a second printed circuit board 91 as shown in FIGS. 1A and 3.

The movable unit 10 includes a camera holder 40 and a movable base 41 (see FIG. 3). The movable unit 10 is fitted into the fixed unit 20 with some gap left between the movable unit 10 and the fixed unit 20. The movable unit 10 rotates (i.e., rolls) around the optical axis 1a of the lens of the camera module 3 with respect to the fixed unit 20. The movable unit 10 also rotates around an axis 1b and an axis 1c with respect to the fixed unit 20. In this case, the axis 1b and the axis 1c are both perpendicular to a fitting direction, in which the movable unit 10 is fitted into the fixed unit 20 while the movable unit 10 is not rotating. Furthermore, these axes 1b and 1c intersect with each other at right angles. A detailed configuration of the movable unit 10 will be described later. The camera module 3 has been mounted on the camera holder 40. The configuration of the movable base 41 will be described later. Rotating the movable unit 10 allows the camera module 3 to rotate. In this embodiment, when the optical axis 1a is perpendicular to both of the axes 1b and 1c, the movable unit 10 (i.e., the camera module 3) is defined to be in a neutral position. In the following description, the direction in which the movable unit 10 (camera module 3) rotates around the axis 1b is defined herein as a “tilting direction” and the direction in which the movable unit 10 (camera module 3) rotates around the axis 1c is defined herein as a “panning direction.” Furthermore, the direction in which the movable unit 10 (camera module 3) rotates (rolls) around the optical axis 1a is defined herein as a “rolling direction.” Note that all of the optical axis 1a and the axes 1b and 1c are virtual axes.

The fixed unit 20 includes a coupling member 50 and a body 51 (see FIG. 3).

The coupling member 50 includes four coupling bars 50a extending from a center portion thereof. Each of the four coupling bars 50a is generally perpendicular to two adjacent coupling bars 50a. Also, each of the four coupling bars 50a is bent such that the tip portion thereof is located below the center portion. The coupling member 50 is screwed onto the body 51 with the movable base 41 interposed between itself and the body 51. Specifically, the respective tip portions of the four coupling bars 50a are screwed onto the body 51.

The fixed unit 20 includes a pair of first coil units 52 and a pair of second coil units 53 to make the movable unit 10 electromagnetically drivable and rotatable (see FIG. 3). The pair of first coil units 52 and the pair of second coil units 53 each corresponds to a drive coil unit.

The pair of first coil units 52 face each other with the optical axis 1a in a neutral position defined as a center, and allows the movable unit 10 to rotate around the axis 1b. Likewise, the pair of second coil units 53 face each other with the optical axis 1a in the neutral position defined as a center, and allows the movable unit 10 to rotate around the axis 1c.

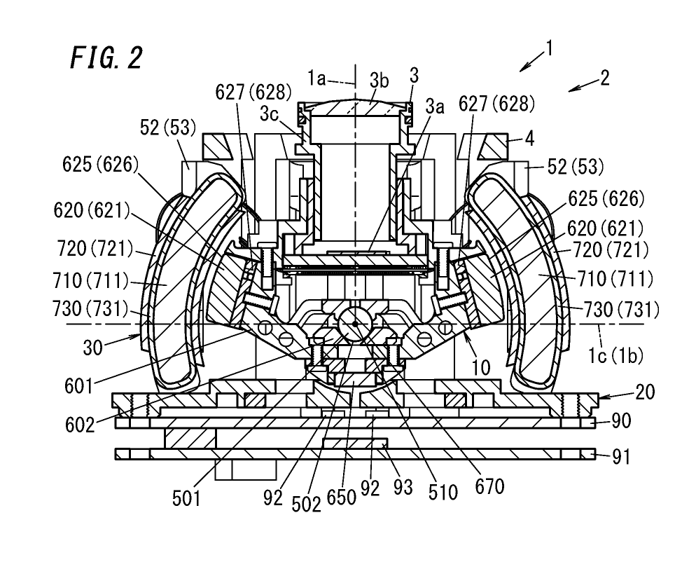

The pair of first coil units 52 each include a first magnetic yoke 710 containing a magnetic material, drive coils 720 and 730, and magnetic yoke holders 740 and 750 (see FIG. 3). Each of the first magnetic yokes 710 has the shape of an arc, of which the center is defined by the center 510 of rotation (see FIG. 2). The drive coils 730 (first coils) are each formed by winding a conductive wire around its associated first magnetic yoke 710 such that its winding direction is defined around the axis 1b and that the pair of first drive magnets 620 (to be described later) are driven in rotation in the rolling direction. After each drive coil 730 has been formed around its associated first magnetic yoke 710, the magnetic yoke holders 740 and 750 are secured with screws onto the first magnetic yoke 710 on both sides of the first magnetic yoke 710 along the axis 1b. Thereafter, the drive coils 720 (second coils) are each formed by winding a conductive wire around its associated first magnetic yoke 710 such that its winding direction is defined around the optical axis 1a when the movable unit 10 is in the neutral position and that the pair of first drive magnets 620 are driven in rotation in the tilting direction. Then, the pair of first coil units 52 are secured with screws onto the upper ring 4 and the body 51 so as to face each other along the axis 1c when viewed from the camera module 3 (see FIGS. 1A and 3). As used herein, the winding direction of the drive coil 720 (730) refers to a direction leading from one end toward the other end of the drive coil 720 (730).

The pair of second coil units 53 each include a second magnetic yoke 711 containing a magnetic material, drive coils 721 and 731, and magnetic yoke holders 741 and 751 (see FIG. 3). Each of the second magnetic yokes 711 has the shape of an arc, of which the center is defined by the center 510 of rotation (see FIG. 2). The drive coils 731 (first coils) are each formed by winding a conductive wire around its associated second magnetic yoke 711 such that its winding direction is defined around the axis 1c and that the pair of second drive magnets 621 (to be described later) are driven in rotation in the rolling direction. After each drive coil 731 has been formed around its associated second magnetic yoke 711, the magnetic yoke holders 741 and 751 are secured with screws onto the second magnetic yoke 711 on both sides of the second magnetic yoke 711 along the axis 1c. Thereafter, the drive coils 721 (second coils) are each formed by winding a conductive wire around its associated second magnetic yoke 711 such that its winding direction is defined around the optical axis 1a when the movable unit 10 is in the neutral position and that the pair of second drive magnets 621 are driven in rotation in the panning direction. Then, the pair of second coil units 53 are secured with screws onto the upper ring 4 and the body 51 so as to face each other along the axis 1b when viewed from the camera module 3 (see FIGS. 2A and 3). As used herein, the winding direction of the drive coil 721 (731) refers to a direction leading from one end toward the other end of the drive coil 721 (731).

The camera module 3 that has been mounted on the camera holder 40 is fixed onto the movable unit 10 with the coupling member 50 interposed between itself and the movable base 41. The upper ring 4 is secured with screws onto the body 51 to sandwich the camera module 3, fixed onto the movable unit 10, between itself and the body 51 (see FIG. 3).

The stopper member 80 is a non-magnetic member. To prevent the movable unit 10 from falling off, the stopper member 80 is secured with screws onto the other side, opposite from the side to which the coupling member 50 is secured, of the body 51, so as to close an opening 706 of the body 51.

The first printed circuit board 90 includes a plurality of (e.g., four) magnetic sensors 92 for detecting rotational positions in the tilting and panning directions of the camera module 3. In this embodiment, the magnetic sensors 92 may be implemented as Hall elements, for example. On the first printed circuit board 90, further assembled is a circuit for controlling the amount of a current allowed to flow through the drive coils 720, 721, 730, and 731 and other components.

On the second printed circuit board 91, assembled are a microcomputer (micro controller) 93 and other components (see FIGS. 2 and 3). The microcomputer 93 performs the function of rotating the movable unit 10 (camera module 3) in the tilting direction, panning direction, and rolling direction and a stabilizer function of reducing unnecessary vibrations of the movable unit 10 by executing a program. In this embodiment, the program is stored in advance in a memory of the computer. Alternatively, the program may also be downloaded via a telecommunications line such as the Internet or distributed after having been stored on a storage medium such as a memory card.

Next, a detailed configuration for the movable base 41 will be described.

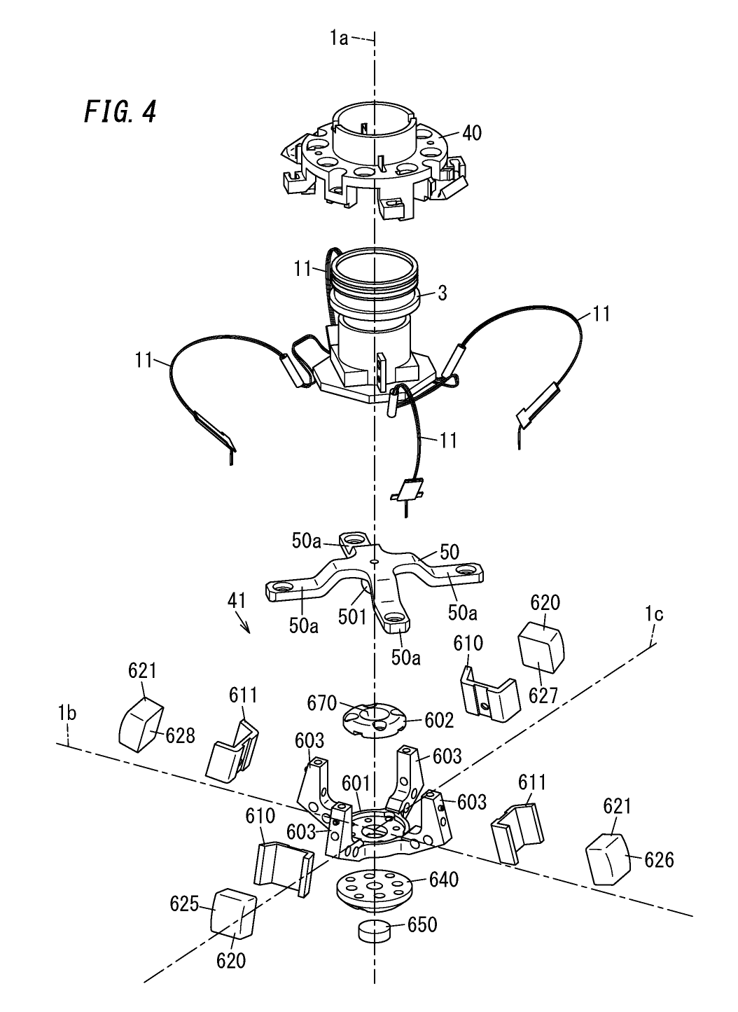

The movable base 41 has a loosely fitting space, and supports the camera module 3 thereon. The movable base 41 includes a coupling body 601 and a first loosely fitting member 602 (see FIG. 4). The movable base 41 further includes a pair of first magnetic back yokes 610 (back yokes), a pair of second magnetic back yokes 611 (back yokes), a pair of first drive magnets 620 (drive magnets), and a pair of second drive magnets 621 (drive magnets) (see FIG. 4). The movable base 41 further includes a bottom plate 640 and a position detecting magnet 650 (see FIG. 4).

The coupling body 601 includes a disk portion and four fixing portions (arms) 603 protruding from the outer periphery of the disk portion toward the camera module 3 (i.e., upward). Two fixing portions 603 out of the four fixing portions 603 face each other along the axis 1b, and the other two fixing portions 603 face each other along the axis 1c. Each of the four fixing portions 603 has a generally L-shape. Each of these four fixing portions 603 faces, one to one, an associated one of the pair of first coil units 52 or an associated one of the pair of second coil units 53. The camera holder 40 is secured with screws to respective tips of the upper portions of the fixing portions 603. This allows the camera holder 40 to be supported by the movable base 41.

The first loosely fitting member 602 has a through hole in a tapered shape. The first loosely fitting member 602 has, as a first loosely fitting face 670, an inner peripheral face of the through hole in the tapered shape (see FIGS. 2 and 4). The first loosely fitting member 602 is secured with screws onto the disk portion of the coupling body 601 such that the first loosely fitting face 670 is exposed to the loosely fitting space.

The pair of first magnetic back yokes 610 are formed of soft iron and each provided one to one for an associated one of two fixing portions 603, facing the pair of first coil units 52, out of the four fixing portions 603. The pair of first magnetic back yokes 610 are secured with screws onto the two L-shaped fixing portions facing the pair of first coil units 52. The pair of second magnetic back yokes 611 are also formed of soft iron and each provided one to one for an associated one of two fixing portions 603, facing the pair of second coil units 53, out of the four fixing portions 603. The pair of second magnetic back yokes 611 are secured with screws onto the two L-shaped fixing portions facing the pair of second coil units 53.

The pair of first drive magnets 620 are each provided one to one for an associated one of the pair of first magnetic back yokes 610. The pair of second drive magnets 621 are each provided one to one for an associated one of the pair of second magnetic back yokes 611. This allows the pair of first drive magnets 620 to face the pair of first coil units 52, and also allows the pair of second drive magnets 621 to face the pair of second coil units 53. In this case, the magnetic pole of a surface 625 (first surface), facing an associated first coil unit 52, of each of the first drive magnets 620 and that of a surface 626 (first surface), facing an associated second coil unit 53, of each of the second drive magnets 621 are the same first magnetic pole (e.g., N-pole).

The surface 625, facing an associated one of the pair of first coil units 52, of each of the pair of first drive magnets 620 is an arc-shaped curved surface, of which the center is defined by the center 510 of rotation, and the center of the arc of the curved surface 625 is aligned with the center of the arc of the curved surface 625 of the associated first magnetic yoke 710 (see FIG. 2). The surface 626, facing an associated one of the pair of second coil units 53, of each of the pair of second drive magnets 621 is an arc-shaped curved surface, of which the center is defined by the center 510 of rotation, and the center of the arc of the curved surface 626 is aligned with the center of the arc of the curved surface of the associated second magnetic yoke 711 (see FIG. 2).

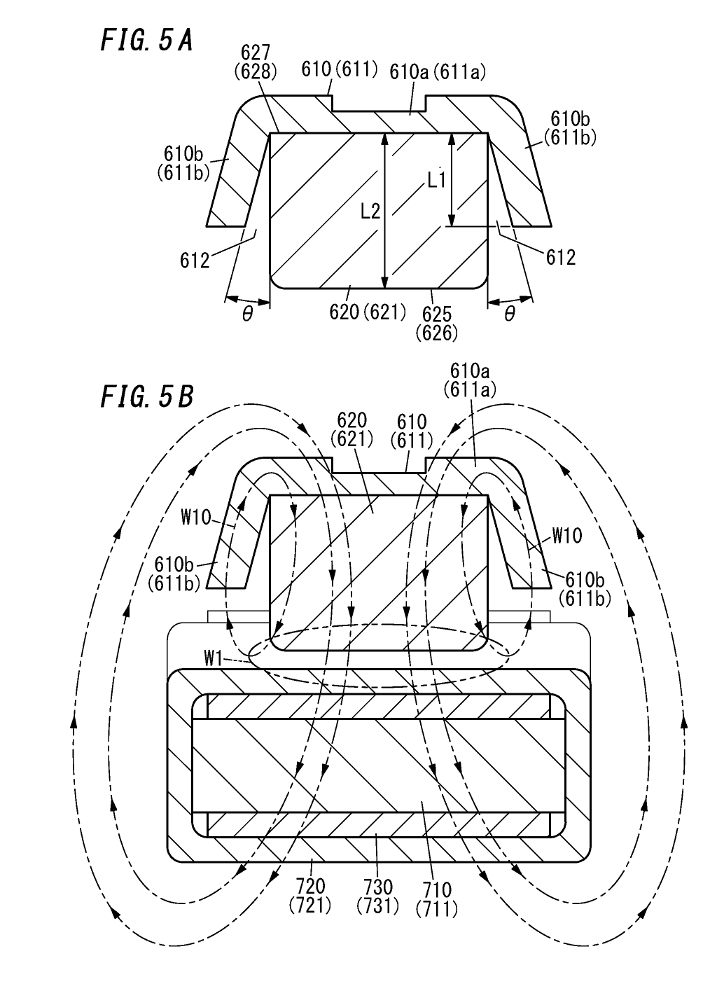

Also, as shown in FIGS. 1B, 5A, and 5B, the surface, facing an associated first drive magnet 620, of each of the first magnetic yokes 710 and the surface 625, facing the first magnetic yoke 710, of the first drive magnet 620 are formed to be parallel to each other when viewed along the optical axis 1a. Likewise, the surface, facing an associated second drive magnet 621, of each of the second magnetic yokes 711 and the surface 626, facing the second magnetic yoke 711, of the second drive magnet 621 are formed to be parallel to each other when viewed along the optical axis 1a.

Each of the first magnetic back yokes 610 includes a base 610a and a pair of yoke protrusions 610b as shown in FIG. 5A.

An associated first drive magnet 620 is attached to the base 610a. Specifically, the first drive magnet 620 is attached to the base 610a such that the base 610a and a surface opposite from the surface 625, i.e., a surface 627 (second surface) having a second magnetic pole (e.g., S-pole) opposite from the first magnetic pole of the surface 625, face each other. For example, the first drive magnet 620 may be bonded with an adhesive to the base 610a.

One yoke protrusion 610b, out of the pair of yoke protrusions 610b, is arranged to face one of two ends in the rolling direction of the first drive magnet 620, and coupled to one of two ends in the rolling direction of the base 610a. The other yoke protrusion 610b, out of the pair of yoke protrusions 610b, is arranged to face the other end in the rolling direction of the first drive magnet 620, and coupled to the other end in the rolling direction of the base 610a. As used herein, the “two ends in the rolling direction of the first drive magnet 620” correspond to both ends, in a direction perpendicular to the direction in which the length L2 (to be described later) is defined, of the first drive magnet 620.

Each yoke protrusion 610b is coupled to the base 610a such that the gap 612 in the rolling direction between the yoke protrusion 610b itself and the first drive magnet 620 widens as the distance from the optical axis 1a increases. That is to say, when the movable unit 10 is in the neutral position, the angle formed between each yoke protrusion 610b and a plane including the optical axis 1a and the axis 1c is θ. Also, the length L1 measured perpendicularly to the base 610a from the tip of the yoke protrusion 610b is shorter than the length L2 representing the thickness of the first drive magnet 620. That is to say, the tip of the yoke protrusion 610b is located closer to the center 510 than the surface 625 with the first magnetic pole of the first drive magnet 620 is. Furthermore, the tip surface of the yoke protrusion 610b is planar.

Each of the second magnetic back yokes 611 includes a base 611a and a pair of yoke protrusions 611b as shown in FIG. 5A.

An associated second drive magnet 621 is attached to the base 611a. Specifically, the second drive magnet 621 is attached to the base 611a such that the base 611a and a surface opposite from the surface 626, i.e., a surface 628 (second surface) having a second magnetic pole (e.g., S-pole) opposite from the first magnetic pole of the surface 626, face each other. For example, the second drive magnet 621 may be bonded with an adhesive to the base 611a.

One yoke protrusion 611b, out of the pair of yoke protrusions 611b, is arranged to face one of two ends in the rolling direction of the second drive magnet 621, and coupled to one of two ends in the rolling direction of the base 611a. The other yoke protrusion 611b, out of the pair of yoke protrusions 611b, is arranged to face the other end in the rolling direction of the second drive magnet 621, and coupled to the other end in the rolling direction of the base 611a. As used herein, the “two ends in the rolling direction of the second drive magnet 621” correspond to both ends, in a direction perpendicular to the direction in which the length L2 is defined, of the second drive magnet 621.

Each yoke protrusion 611b is coupled to the base 611a such that the gap 612 in the rolling direction between the yoke protrusion 611b itself and the second drive magnet 621 widens as the distance from the optical axis 1a increases. That is to say, when the movable unit 10 is in the neutral position, the angle formed between each yoke protrusion 611b and a plane including the optical axis 1a and the axis 1b is θ. Also, the length L1 measured perpendicularly to the base 611a from the tip of the yoke protrusion 611b is shorter than the length L2 representing the thickness of the second drive magnet 621. That is to say, the tip of the yoke protrusion 611b is located closer to the center point 510 than the surface 626 with the first magnetic pole of the second drive magnet 621 is. Furthermore, the tip surface of the yoke protrusion 611b is planar.

The bottom plate 640 is a non-magnetic member and may be made of brass, for example. The bottom plate 640 is provided for the other side, opposite from the side with the first loosely fitting member 602, of the coupling body 601 to define the bottom of the movable unit 10 (i.e., the bottom of the movable base 41). The bottom plate 640 is secured with screws onto the coupling body 601. The bottom plate 640 serves as a counterweight. Having the bottom plate 640 serve as a counterweight allows the center 510 of rotation to agree with the center of gravity of the movable unit 10. That is why when external force is applied to the entire movable unit 10, the moment of rotation of the movable unit 10 around the axis 1b and the moment of rotation of the movable unit 10 around the axis 1c both decrease. This allows the movable unit 10 (or the camera module 3) to be held in the neutral position, or to rotate around the axes 1b and 1c, with less driving force.

The position detecting magnet 650 is provided for a center portion of an exposed surface of the bottom plate 640.

As the movable unit 10 rotates, the position detecting magnet 650 changes its position, thus causing a variation in the magnetic force applied to the four magnetic sensors 92 provided for the first printed circuit board 90. The four magnetic sensors 92 detect a variation, caused by the rotation of the position detecting magnet 650, in the magnetic force, and calculate two-dimensional angles of rotation with respect to the axes 1b and 1c. This allows the four magnetic sensors 92 to detect respective rotational positions in the tilting and panning directions. In addition, the camera device 1 further includes, separately from the four magnetic sensors 92, another magnetic sensor for detecting the rotation of the movable unit 10 (i.e., the rotation of the camera unit 3) around the optical axis 1a. Note that the sensor for detecting the rotation around the optical axis 1a does not have to be a magnetic sensor but may also be a gyrosensor, for example.

The coupling member 50 includes, at a center portion thereof (i.e., in a recess formed by respective bends of the four coupling bars), a second loosely fitting member 501 in a spherical shape (see FIGS. 2 and 4). The second loosely fitting member 501 has a second loosely fitting face 502 with a raised spherical surface (see FIG. 2). The spherical second loosely fitting member 501 is bonded with an adhesive onto the center portion (recess) of the coupling member 50.

The coupling member 50 and the first loosely fitting member 602 are joined together. Specifically, the first loosely fitting face 670 of the first loosely fitting member 602 is brought into point or line contact with, and fitted with a narrow gap left (i.e., loosely fitted) onto, the second loosely fitting face 502 of the second loosely fitting member 501. This allows the coupling member 50 to pivotally support the movable unit 10 so as to make the movable unit 10 freely rotatable. In this case, the center of the spherical second loosely fitting member 501 defines the center 510 of rotation.

The stopper member 80 has a recess, and is secured onto the body 51 such that a lower portion of the position detecting magnet 650 is introduced into the recess. A gap is left between the inner peripheral face of the recess of the stopper member 80 and the bottom of the bottom plate 640. The inner peripheral face of the recess of the stopper member 80 and the outer peripheral face of the bottom of the bottom plate 640 have curved faces that face each other. In this case, a gap is also left between the inner peripheral face of the recess of the stopper member 80 and the position detecting magnet 650. This gap is wide enough, even when the bottom plate 640 or the position detecting magnet 650 comes into contact with the stopper member 80, for the first drive magnets 620 and the second drive magnets 621 to return to their home positions due to their magnetism. This prevents, even when the camera module 3 is pressed toward the first printed circuit board 90, the camera module 3 from falling off, and also allows the pair of first drive magnets 620 and the pair of second drive magnets 621 to return to their home positions.

Note that the position detecting magnet 650 is suitably arranged inside of the outer periphery of the bottom of the bottom plate 640.

In this case, the pair of first drive magnets 620 serves as attracting magnets, thus producing first magnetic attraction forces between the pair of first drive magnets 620 and the first magnetic yokes 710 that face the first drive magnets 620. Likewise, the pair of second drive magnets 621 also serves as attracting magnets, thus producing second magnetic attraction forces between the pair of second drive magnets 621 and the second magnetic yokes 711 that face the second drive magnets 621. The vector direction of each of the first magnetic attraction forces is parallel to a centerline that connects together the center 510 of rotation, the center of mass of an associated one of the first magnetic yokes 710, and the center of mass of an associated one of the first drive magnets 620. The vector direction of each of the second magnetic attraction forces is parallel to a centerline that connects together the center 510 of rotation, the center of mass of an associated one of the second magnetic yokes 711, and the center of mass of an associated one of the second drive magnets 621.

The first and second magnetic attraction forces become normal forces produced by the second loosely fitting member 501 of the fixed unit 20 with respect to the first loosely fitting member 602. Also, when the movable unit 10 is in the neutral position, the magnetic attraction forces of the movable unit 10 define a synthetic vector along the optical axis 1a of the respective vectors of the first and second magnetic attraction forces. This force balance between the first magnetic attraction forces, the second magnetic attraction forces, and the synthetic vector resembles the dynamic configuration of a balancing toy, and allows the movable unit 10 to rotate in three axis directions with good stability.

The camera device 1 of this embodiment allows the movable unit 10 to rotate two-dimensionally (i.e., pan and tilt) by supplying electricity to the pair of drive coils 720 and the pair of drive coils 721. In addition, the camera device 1 also allows the movable unit 10 to rotate (i.e., to roll) around the optical axis 1a by supplying electricity to the pair of drive coils 730 and the pair of drive coils 731.

In this embodiment, the first magnetic back yokes 610 each include a pair of yoke protrusions 610b, and therefore, each magnetic line of force W10, forming part of the magnetic flux W1 of the first drive magnet 620, passes through the yoke protrusion 610b and the base 610a in this order and then returns to the first drive magnet 620 (see FIG. 5B). That is to say, the magnetic line of force W10 forming part of the magnetic flux W1 returns to the first drive magnet 620 without passing through the first magnetic yoke 710. Likewise, the second magnetic back yokes 611 each include a pair of yoke protrusions 611b, and therefore, each magnetic line of force W10, forming part of the magnetic flux W1 of the second drive magnet 621, passes through the yoke protrusion 611b and the base 611a in this order and then returns to the second drive magnet 621 (see FIG. 5B). That is to say, the magnetic line of force W10 forming part of the magnetic flux W1 returns to the second drive magnet 621 without passing through the second magnetic yoke 711.

On the other hand, a magnetic line of force emitted from a comparative drive magnet attached to a back yoke with no yoke protrusions (a comparative back yoke) passes through a comparative magnetic yoke facing the comparative drive magnet and the comparative back yoke in this order, and then returns to the comparative drive magnet.

Thus, the attraction force produced between the first drive magnet 620 and the first magnetic yoke 710 becomes weaker than the attraction force produced between the comparative drive magnet and the comparative magnetic yoke. This allows the movable unit 10 (camera module 3) to have an increased angle of rotation in the rolling direction.

It is possible to decrease the magnetic force of the first drive magnet 620 itself in order to increase the angle of rotation in the rolling direction. In that case, the magnetic flux (magnetic lines of force) of the first drive magnet 620 decreases. This would prevent a torque required to rotate the movable unit 10 in the rolling and tilting directions from being produced, thus possibly making it impossible to rotate the movable unit 10 in the rolling and tilting directions as intended. Therefore, providing the yoke protrusions 610b for the first magnetic back yoke 610 as is done in this embodiment allows the attraction force between the first drive magnet 620 and the first magnetic yoke 710 to be varied (or weakened) without changing the magnetic force of the first drive magnet 620 itself. This allows the actuator 2 according to this embodiment to produce a torque required to rotate the movable unit 10 in the rolling and tilting directions and weaken the magnetic coupling force between the first drive magnet 620 and the first magnetic yoke 710.

When the comparative movable unit including the comparative back yoke rotates in the rolling direction, a surface, facing the comparative magnetic yoke, of the comparative drive magnet will have a first area coming closer toward the comparative magnetic yoke and a second area going away from the comparative magnetic yoke. In that case, the magnetic flux of the comparative drive magnet becomes denser in the first area and sparser in the second area. Thus, the attraction between the first area and the comparative magnetic yoke becomes greater than the attraction between the second area and the comparative magnetic yoke. This produces force of making the comparative movable unit go back to the state before the rotation (restitution force).

In contrast, according to this embodiment, even when the movable unit 10 rotates in the rolling direction, the magnetic line of force W10, forming part of the magnetic flux W1 of the first drive magnet 620, passes through the yoke protrusion 610b. Therefore, some of the dense magnetic lines of force on an area, close to the first magnetic yoke 710, of the surface 625 pass through the yoke protrusion 610b. Thus, the attraction between the area close to the first magnetic yoke 710 of the surface 625 and the first magnetic yoke 710 becomes weaker than the attraction between the first area and the comparative magnetic yoke. That is to say, the restitution force produced in the movable unit 10 becomes weaker than the restitution force produced in the comparative movable unit.

Therefore, providing the pair of yoke protrusions 610b for the first magnetic back yoke 610 allows the magnetic flux (magnetic lines of force), contributing to the restitution force, between the first drive magnet 620 and the first magnetic yoke 710 to be decreased, thus reducing the restitution force.

Likewise, providing the pair of yoke protrusions 611b for the second magnetic back yoke 611 allows the attraction force between the second drive magnet 621 and the second magnetic yoke 711 to be varied (or weakened) without changing the magnetic force of the second drive magnet 621 itself. This allows the actuator 2 according to this embodiment to produce a torque required to rotate the movable unit 10 in the rolling and panning directions and weaken the magnetic coupling force between the second drive magnet 621 and the second magnetic yoke 711. In addition, providing the pair of yoke protrusions 611b for the second magnetic back yoke 611 allows the magnetic flux (magnetic lines of force), contributing to the restitution force, between the second drive magnet 621 and the second magnetic yoke 711 to be decreased, thus reducing the restitution force.

To form the first magnetic back yokes 610 and second magnetic back yokes 611 according to this embodiment, the angle θ and length L1 described above need to be set (determined).

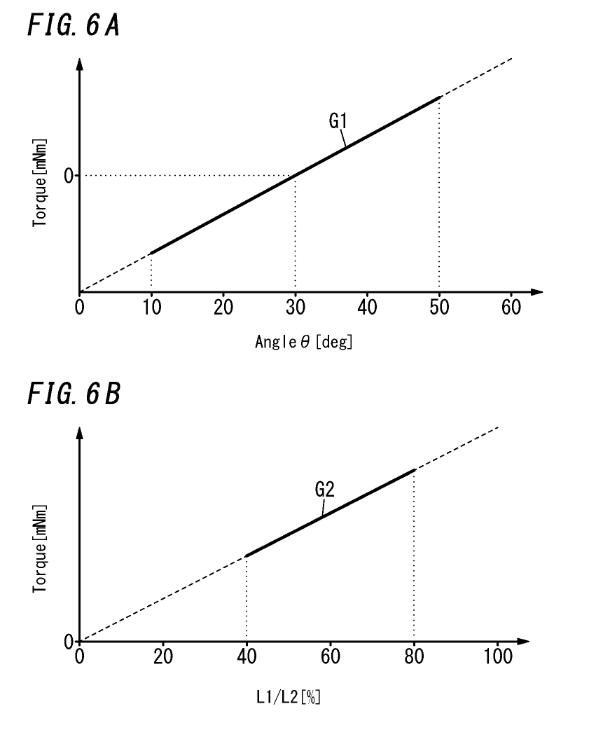

FIG. 6A illustrates a graph G1 showing a relationship between the torque in the rolling direction and the angle θ on the supposition that the amount of current flowing through the drive coils 730 and 731 with the movable unit 10 (camera module 3) rotated 5 degrees in the rolling direction is zero. As shown in FIG. 6A, the larger the angle θ is, the greater the torque in the rolling direction becomes. In this case, if the torque were extremely small (i.e., as the negative torque value increases), the angle of rotation in the rolling direction would decrease. On the other hand, if the torque were extremely large (i.e., as the positive torque value increases), the movable unit 10 would further rotate spontaneously. These inconveniences should be avoided. Therefore, the relationship between the torque in the rolling direction and the angle θ suitably falls within the solid line range of the graph G1 shown in FIG. 6A. Specifically, an angle θ of 30±20 degrees is suitably applied as the angle θ. The angle θ is more suitably 30 degrees. Note that when the angle θ exceeds 30 degrees, the torque has a positive value. This indicates a state where the movable unit 10 is going to further rotate in the rotational direction. The larger the angle θ is, the smaller the magnetic resistance between the first drive magnet 620 (second drive magnet 621) and the first magnetic yoke 710 (second magnetic yoke 711) becomes. If the movable unit 10 (camera module 3) rotates in the rolling direction in a situation where the angle θ is larger than 30 degrees, then the movable unit 10 further rotates in the rotational direction to further reduce the magnetic resistance. That is to say, the movable unit 10 further rotates in the rotational direction to allow an even larger number of magnetic lines of force to enter the yoke protrusions 610b (611b). In a situation where the torque has a positive value, as the torque value increases, the movable unit 10 further rotates in the rotational direction, thus making it difficult for the movable unit 10 to recover the state before the rotation in the rolling direction. For this reason, if the angle θ is greater than 30 degrees, the state before the rotation in the rolling direction needs to be recovered by control such as electromagnetic driving.

In addition, as the angle θ increases, the torque in the rolling direction also increases when a current is allowed to flow through the drive coils 730 and 731. As the angle θ increases, the torque in the panning and tilting directions increases as much as the torque in the rolling direction, both in a situation where a current is flowing through the drive coils 730, 731 and in a situation where no current is flowing through the drive coils 730, 731.

FIG. 6B illustrates a graph G2 showing a relationship between the torque in the rolling direction and the ratio of the length L1 to the length L2 (hereinafter referred to as a “magnet thickness ratio”) of the movable unit 10 (camera module 3) in a situation where a current is flowing through the drive coils 730, 731. As shown in FIG. 6B, the larger the magnet thickness ratio is, the greater the torque in the rolling direction becomes. In this case, if the magnet thickness ratio exceeds 80%, the first magnetic back yokes 610 (or second magnetic back yokes 611) could interfere with the first coil units 52 (or the second coil units 53). On the other hand, if the magnet thickness ratio becomes less than 40%, then the effect produced by providing the yoke protrusions 610b (611b) weakens and the angle of rotation in the rolling direction decreases. As shown in FIG. 6B, as the length L1 increases (i.e., as the magnet thickness ratio increases), more and more magnetic lines of force emitted from the first drive magnets 620 (or the second drive magnets 621) enter the yoke protrusions 610b (611b), thus increasing the rotational torque in the rolling direction. When the movable unit 10 rotates in the tilting direction (or panning direction), a torque is produced between the first drive magnets 620 (or second drive magnets 621) and the drive coils 720 (721). In this case, as the length L1 of the yoke protrusions 610b (611b) increases, an increasing number of magnetic lines of force produced by the drive coils 720 (or 721) enter the yoke protrusions 610b (611b). Thus, the torque produced between the first drive magnets 620 (or second drive magnets 621) and the drive coils 720 (721) decreases. That is to say, if the length L1 of the yoke protrusions 610b (611b) is increased to increase the rotational torque in the rolling direction, then the rotational torques in the panning and tilting directions could decrease. In short, a tradeoff is inevitable between the magnitude of the rotational torque in the rolling direction and the magnitudes of the rotational torques in the panning and tilting directions. For these reasons, the length L1 is suitably determined such that the magnet thickness ratio falls within the range of 60±20%. Among other things, the length L1 is suitably determined such that the magnet thickness ratio is 60%.

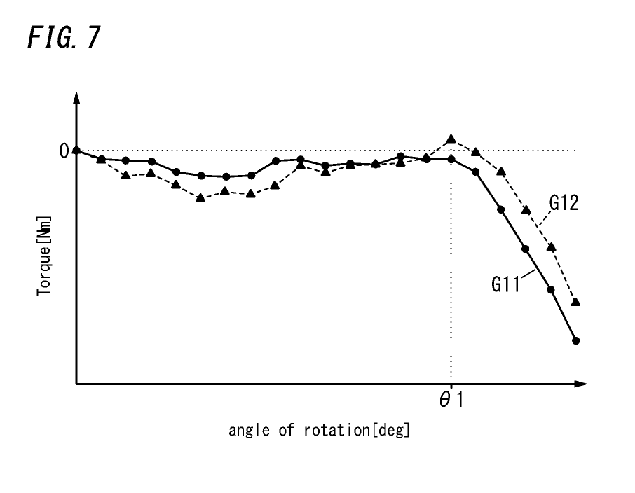

FIG. 7 illustrates how the torque varies with the angle of rotation in the tilting direction (or panning direction) of the movable unit 10 (camera module 3) in a state where no current is flowing through the drive coils 730 (or 731). The solid line graph G11 illustrates how the torque varies in the tilting direction (or panning direction) when the first magnetic back yokes 610 (or second magnetic back yokes 611) with the yoke protrusions 610b (or 611b) are used. The dotted line graph G12 illustrates how the torque varies in the tilting direction (or panning direction) when back yokes 610 with no yoke protrusions 610b (611b) (i.e., the comparative back yokes described above) are used.

As indicated by the dotted line graph, when the angle of rotation is around θ1, the torque value is greater than (i.e., exceeds) zero. Thus, using the comparative back yokes causes cogging at an angle of rotation of around θ1. On the other hand, the solid line graph G1 indicates that the torque value is never greater than (i.e., never exceeds) zero at any angle of rotation. That is to say, using the first magnetic back yokes 610 (or second magnetic back yokes 611) with the yoke protrusions 610b (611b) causes no cogging. Thus, using the first magnetic back yokes 610 (or second magnetic back yokes 611) with the yoke protrusions 610b (611b) prevents cogging from being caused in the tilting direction (or panning direction).

(Variations)

Next, variations will be enumerated one after another. Note that any of the variations to be described below may be combined as appropriate with the embodiment described above.

In the embodiment described above, the angle θ formed by the yoke protrusions 610b, 611b may be equal to zero. That is to say, the gap 162 in the rolling direction between the yoke protrusions 610b (611b) and the first drive magnet 620 may be constant.

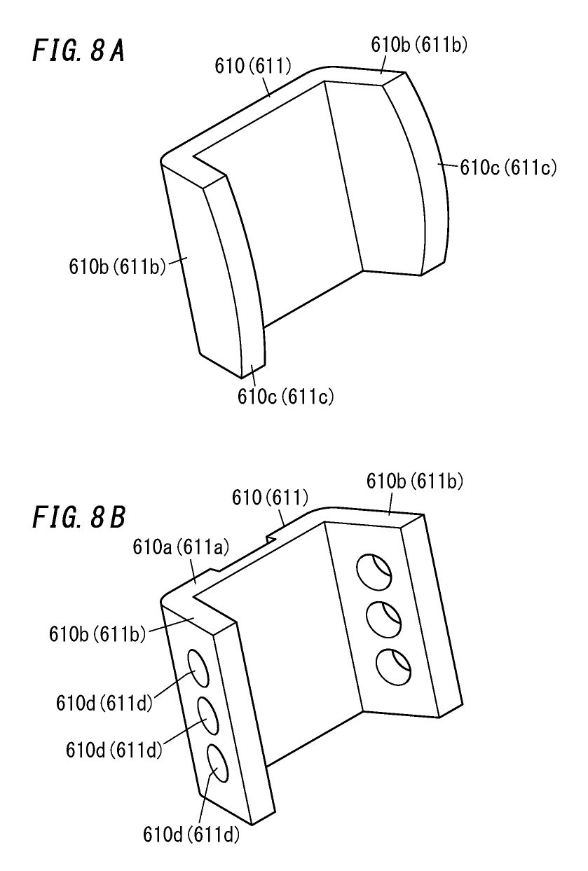

Also, in the embodiment described above, the tip of the yoke protrusions 610b (611b) has a linear shape along the optical axis 1a. However, this is only an example and should not be construed as limiting. Alternatively, the tip 610c (or 611c) of the yoke protrusions 610b (611b) may also be a curved surface along the optical axis 1a (see FIG. 8A). Specifically, the surface at the tip of the yoke protrusions 610b (611b) is a curved surface sloping away from the optical axis 1a as the distance from each of two ends along the optical axis 1a increases toward the center. In that case, such an arc-shaped surface may be formed by filleting such that the yoke protrusions 610b (611b) have rounded smooth tips along the optical axis 1a. Then, compared to a situation where the yoke protrusions 610b (611b) have linear tips along the optical axis 1a, the magnetic resistance increases, and therefore, the number of magnetic lines of force passing through the yoke protrusions 610b (611b) decreases. That is to say, the torque in the rolling direction decreases. However, since a tradeoff is inevitable between the magnitude of the rotational torque in the rolling direction and the magnitudes of the rotational torques in the panning and tilting directions as described above, the rotational torques in the panning and tilting directions increase in such a situation.

Alternatively, each of the yoke protrusions 610b (611b) may have a single or multiple through holes 610d (611d) on a surface thereof facing the first drive magnet 620 (or second drive magnet 621) attached to the base 610a (611a) as shown in FIG. 8B. In that case, cutting the through holes 610d (611d) allows the air to pass therethrough, thus increasing the magnetic resistance compared to a situation where no through holes 610d (or 611d) are provided. That is to say, the torque in the rolling direction decreases. Since the torque in the rolling direction decreases, the rotational torques in the panning and tilting directions increase. Optionally, in the first magnetic back yokes 610 (or second magnetic back yokes 611), the yoke protrusions 610b (611b) shown in FIG. 8A may have a single or multiple through holes 610d (or 611d). Note that the through holes 610d (or 611d) do not have to be circular as shown in FIG. 8B but may also be elliptical, rectangular, or any other polygonal ones as well. Alternatively, the yoke protrusions 610b (611b) may be provided with recesses or grooves instead of the through holes 610d (611d).

In the embodiment described above, the pair of first magnetic back yokes 610 and the pair of second magnetic back yokes 611 both have yoke protrusions. However, this is only an example and should not be construed as limiting. Alternatively, at least one pair of magnetic back yokes, selected from the group consisting of the pair of first magnetic back yokes 610 and the pair of second magnetic back yokes 611, may have yoke protrusions.

Furthermore, in the embodiment described above, the yoke protrusions 610b are provided at both ends of the base 610a of the first magnetic back yokes 610. However, this is only an example and should not be construed as limiting. Alternatively, the yoke protrusion 610b may be provided at only one of the two ends of the base 610a of the first magnetic back yokes 610. That is to say, the yoke protrusion 610b may be provided on at least one of the two ends of the base 610a of the first magnetic back yokes 610. Likewise, the yoke protrusion 611b may be provided on at least one of the two ends of the base 611a of the second magnetic back yokes 611.

Furthermore, in the embodiment described above, the actuator 2 is configured to rotate the movable unit 10 in the three directions, namely, the rolling direction, panning direction, and tilting direction. However, this is only an example and should not be construed as limiting. Rather the actuator 2 may be configured to rotate the movable unit 10 in at least the rolling direction.

Furthermore, in the embodiment described above, the first magnetic back yokes 610 and the second magnetic back yokes 611 are provided separately from, and secured either with screws or adhesive or by fitting to, the coupling body 601 of the movable base 41 of the movable unit 10. However, this is only an example and should not be construed as limiting. Alternatively, the first magnetic back yokes 610 and the second magnetic back yokes 611 may also be integrated with the coupling body 601. For example, the pair of first magnetic back yokes 610, the pair of second magnetic back yokes 611, and the coupling body 601 may be formed as a continuous member by subjecting a single plate member to pressing. In that case, the coupling body 601 may be made of the same material (such as soft iron) as the first magnetic back yokes 610 and the second magnetic back yokes 611.

Furthermore, in the embodiment described above, the actuator 2 is configured to be applied to the camera device 1. However, this is only an example and should not be construed as limiting. Alternatively, the actuator 2 may also be applied to a laser pointer, a light fixture, or any other type of device as well. For example, when the actuator 2 is applied to a laser pointer, a module for emitting a laser beam is provided for the movable unit 10. On the other hand, when the actuator 2 is applied to a light fixture, a light source is provided for the movable unit 10.

(Resume)

As can be seen from the foregoing description, an actuator (2) according to a first aspect includes a movable unit (10), a fixed unit (20), and a plurality of drive coil units (including a first coil unit 52 and a second coil unit 53). The actuator (2) further includes a plurality of drive magnets (including a first drive magnet 620 and a second drive magnet 621), and a plurality of back yokes (including a first magnetic back yoke 610 and a second magnetic back yoke 611). The movable unit (10) holds an object to be driven thereon. The fixed unit (20) holds the movable unit (10) thereon so as to allow the movable unit (10) to rotate around a predetermined first axis. The plurality of drive coil units are provided for the fixed unit (20), arranged to face each other with respect to the first axis (optical axis 1a), and configured to cause the movable unit (10) to rotate around the first axis. The plurality of drive magnets are provided for the movable unit (10). The plurality of drive magnets are each arranged between the first axis and a facing one of the plurality of drive coil units such that respective first surfaces (surfaces 625 or 626), having the same first magnetic pole, of the plurality of drive magnets face the plurality of drive coil units. The plurality of back yokes are each provided one to one for, and attached to, an associated one of the plurality of drive magnets so as to face a second surface of the associated one of the plurality of drive magnets. The second surface has a second magnetic pole opposite from the first magnetic pole. The plurality of drive coil units each include a yoke (a first magnetic yoke 710 or a second magnetic yoke 711) containing a magnetic material and a coil (a drive coil 730, 731) formed by winding a conductive wire around the yoke in a direction defined around a second axis (such as an axis 1b or an axis 1c) that is perpendicular to the first axis. The plurality of back yokes includes at least one pair of back yokes facing each other with respect to the first axis. Each of the at least one pair of back yokes includes a base (a base 610a, 611a) and a yoke protrusion (a yoke protrusion 610b, 611b). An associated one of the plurality of drive magnets is attached to the base. The yoke protrusion is coupled to the base and arranged to face at least one out of two ends of the associated drive magnet in a rolling direction of a movable unit (10).

According to this configuration, a pair of back yokes, among a plurality of back yokes, each include a yoke protrusion. Thus, part of the magnetic flux (i.e., magnetic lines of force) produced from the magnetic magnets attached to the pair of back yokes enters the yoke protrusions, thus weakening the attraction force produced between the drive magnets attached to the back yokes with the yoke protrusions and the yokes facing the drive magnets. This allows the actuator 2 to increase the angle of rotation in the rolling direction of the movable unit 10. Thus, the actuator 2 is able to obtain a torque required to rotate the movable unit 10 in the rolling direction and weaken the magnetic coupling force between the drive magnets and the yokes.

In an actuator (2) according to a second aspect, which may be implemented in conjunction with the first aspect, the yoke protrusion is arranged to face each of the two ends of the associated drive magnet. This configuration allows a larger number of magnetic lines of force to enter the yoke protrusions from the magnetic magnets, thus further weakening the attraction force produced between the drive magnets attached to the back yokes with the yoke protrusions and the yokes facing the drive magnets.

In an actuator (2) according to a third aspect, which may be implemented in conjunction with the first or second aspect, the yoke protrusion is provided for every one of the plurality of back yokes. This configuration ensures the actuator 2 to obtain a torque required to rotate the movable unit 10 in the rolling direction and weaken the magnetic coupling force between the drive magnets and the yokes.

In an actuator (2) according to a fourth aspect, which may be implemented in conjunction with any one of the first to third aspects, the yoke protrusion is coupled to the base such that a gap (612) in the rotational direction (i.e., the rolling direction) between the yoke protrusion itself and one drive magnet, attached to the back yoke with the yoke protrusion, out of the plurality of drive magnets widens as a distance from the first axis increases. This configuration allows a larger number of magnetic lines of force to enter the yoke protrusions, thus further weakening the attraction force produced between the drive magnets attached to the back yokes with the yoke protrusions and the yokes facing the drive magnets.

In an actuator (2) according to a fifth aspect, which may be implemented in conjunction with any one of the first to fourth aspects, a tip of the yoke protrusion is located closer to the first axis than the first surface with the first magnetic pole of the one drive magnet, attached to the back yoke with the yoke protrusion, out of the plurality of drive magnets is. This configuration reduces the chances of the drive magnets and the yokes interfering with each other while the movable unit 10 is rotating (in the rolling direction) around the first axis.

In an actuator (2) according to a sixth aspect, which may be implemented in conjunction with any one of the first to fifth aspects, respective facing surfaces of the yoke included in each of the plurality of drive coil units and the one drive magnet, facing the drive coil unit with the yoke, out of the plurality of drive magnets are arranged to be parallel to each other when viewed along the first axis. According to this configuration, the magnetic lines of force are emitted from the drive magnets perpendicularly to the facing surfaces. Thus, providing the yoke protrusions allows some of the magnetic lines of force to enter the yoke protrusions.

In an actuator (2) according to a seventh aspect, which may be implemented in conjunction with any one of the first to sixth aspects, the plurality of drive coil units each further includes a second coil (drive coil 720 or 721) formed by winding a conductive wire around the yoke along the first axis and different from a first coil as the coil. The movable unit (10) is driven around the second axis in rotation by the second coil included in each of the plurality of drive coil units and the plurality of drive magnets. This configuration allows the actuator 2 to rotate the movable unit 10 in at least two directions.

In an actuator (2) according to an eighth aspect, which may be implemented in conjunction with the seventh aspect, the respective facing surfaces of the yoke included in each of the plurality of drive coil units and the one drive magnet, facing the drive coil unit with the yoke, out of the plurality of drive magnets are arc-shaped curved surfaces, each of which has a center thereof defined by a center (510) of rotation around the first axis and the second axis. This configuration reduces the chances of the drive magnets and the yokes interfering with each other while the movable unit 10 is rotating around the second axis (in either the panning direction or the tilting direction).

In an actuator (2) according to a ninth aspect, which may be implemented in conjunction with the seventh or eighth aspect, the surface at a tip of the yoke protrusion is a curved surface sloping away from the first axis as a distance from each of two ends thereof along the first axis increases toward the center. This configuration decreases the torque produced when the movable unit 10 rotates around the first axis but increases the torque produced when the movable unit 10 rotates around the second axis.

In an actuator (2) according to a tenth aspect, which may be implemented in conjunction with any one of the seventh to ninth aspects, the yoke protrusion has a through hole (610d or 611d) cut through a surface thereof facing one drive magnet, attached to the base coupled to the yoke protrusion, out of the plurality of drive magnets. This configuration decreases the torque produced when the movable unit 10 rotates around the first axis but increases the torque produced when the movable unit 10 rotates around the second axis.

An actuator (2) according to an eleventh aspect, which may be implemented in conjunction with any one of the first to tenth aspects, further includes a coupling body (601) formed of the same material as the plurality of back yokes and configured to couple the plurality of back yokes together. This configuration allows the back yokes to absorb more magnetic lines of force from the drive magnets.

A camera device (1) according to a twelfth aspect includes the actuator (2) according to any one of the first to eleventh aspects; and a camera module (3) as the object to be driven. This configuration allows the camera device (1) to obtain a torque required to rotate the movable unit (10), i.e., the camera module (3), in the rolling direction and weaken the magnetic coupling force between the drive magnets and the yokes.

1. An actuator comprising:
a movable holder configured to hold an object to be driven thereon;
a fixed holder configured to hold the movable holder thereon so as to allow the movable holder to rotate around a predetermined first axis;
a plurality of drive coil members provided for the fixed holder, arranged to face each other with respect to the first axis, and configured to cause the movable holder to rotate around the first axis;
a plurality of drive magnets provided for the movable holder, the plurality of drive magnets being each arranged between the first axis and a facing one of the plurality of drive coil members such that respective first surfaces, having the same first magnetic pole, of the plurality of drive magnets face the plurality of drive coil members; and
a plurality of back yokes, each being provided one to one for, and attached to, an associated one of the plurality of drive magnets so as to face a second surface of the associated one of the plurality of drive magnets, the second surface having a second magnetic pole opposite from the first magnetic pole,
the plurality of drive coil members each including a yoke containing a magnetic material and a coil formed by winding a conductive wire around the yoke in a direction defined around a second axis that is perpendicular to the first axis,
the plurality of back yokes including at least one pair of back yokes facing each other with respect to the first axis, each of the at least one pair of back yokes including: a base to which an associated one of the plurality of drive magnets is attached; and a yoke protrusion coupled to the base and arranged to face at least one out of two ends of the associated drive magnet in a rotational direction of the movable holder.

2. The actuator of claim 1, wherein
the yoke protrusion is arranged to face each of the two ends of the associated drive magnet.

3. The actuator of claim 1, wherein
the yoke protrusion is provided for every one of the plurality of back yokes.

4. The actuator of claim 1, wherein
the yoke protrusion is coupled to the base such that a gap in the rotational direction between the yoke protrusion itself and one drive magnet, attached to the back yoke with the yoke protrusion, out of the plurality of drive magnets widens as a distance from the first axis increases.

5. The actuator of claim 1, wherein
a tip of the yoke protrusion is located closer to the first axis than the first surface with the first magnetic pole of the one drive magnet, attached to the back yoke with the yoke protrusion, out of the plurality of drive magnets is.

6. The actuator of claim 1, wherein
respective facing surfaces of the yoke included in each of the plurality of drive coil members and the one drive magnet, facing the drive coil member with the yoke, out of the plurality of drive magnets are arranged to be parallel to each other when viewed along the first axis.

7. The actuator of claim 1, wherein
the plurality of drive coil members each further includes a second coil formed by winding a conductive wire around the yoke along the first axis and different from a first coil as the coil, and
the movable holder is driven around the second axis in rotation by the second coil included in each of the plurality of drive coil members and the plurality of drive magnets.

8. The actuator of claim 7, wherein
the respective facing surfaces of the yoke included in each of the plurality of drive coil members and the one drive magnet, facing the drive coil member with the yoke, out of the plurality of drive magnets are arc-shaped curved surfaces, each of which has a center thereof defined by a center of rotation around the first axis and the second axis.

9. The actuator of claim 7, wherein
the surface at a tip of the yoke protrusion is a curved surface sloping away from the first axis as a distance from each of two ends thereof along the first axis increases toward the center.

10. The actuator of claim 7, wherein
the yoke protrusion has a through hole cut through a surface thereof facing one drive magnet, attached to the base coupled to the yoke protrusion, out of the plurality of drive magnets.

11. The actuator of claim 1, further comprising a coupling body formed of the same material as the plurality of back yokes and configured to couple the plurality of back yokes together.

12. A camera device comprising:
the actuator of claim 1; and
a camera module as the object to be driven.
